(19) United States
(12) Patent Application Publication
(10) Pub. No.: US 2017/0022780 A1
(43) Pub. Date: Jan. 26, 2017

(54) Protection For Elastomeric Materials Used In Down-Hole Tools

(71) Applicant: C&J Spec-Rent Services, Inc., Houston, TX (US)

(72) Inventor: Kevin J. Berry, Houston, TX (US)

(21) Appl. No.: 14/808,042

(22) Filed: Jul. 24, 2015

(51) Int. Cl. E21B 33/12; B32B 37/14

(52) U.S. Cl. CPC E21B 33/1208; B32B 37/144; B32B 2307/31; B32B 2307/5825; B32B 2307/736; B32B 2327/12; B32B 2581/00

(57) ABSTRACT

Down-hole tools, methods of manufacturing the down-hole tools and methods of running the down-hole tools downhole are generally described herein. The down-hole tools generally include a sealing assembly adapted for use down-hole, wherein the sealing assembly includes: a substrate including an elastomeric material; and a heat shrink film adhered to at least a portion of the substrate, wherein the heat shrink film includes a thickness when adhered to the at least a portion of the substrate in a range of about 7.5 mil to about 30 mil and exhibits an Elmendorf tear strength (as measured by ASTM D-1922) in a range of about 1000 g to about 5000 g.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD

The present disclosure generally relates to down-hole tools. In particular, embodiments contained herein relate to protection of elastomeric materials for use in down-hole tools.

### BACKGROUND

This section introduces information from the art that may be related to or provide context for some aspects of the techniques described herein and/or claimed below. This information is background facilitating a better understanding of that which is disclosed herein. Such background may include a discussion of “related” art. That such art is related in no way implies that it is also “prior” art. The related art may or may not be prior art. The discussion is to be read in this light, and not as admissions of prior art.

Fluids, such as water and hydrocarbon fluids (e.g., oil and gas), are found in subterranean portions of geological formations or reservoirs. Wells are often drilled into these formations for extracting such fluids. Wells may be completed in a variety of ways, including open hole and cased hole configurations, for example. The processes involved in completing well bores and producing fluids from them often require isolation of one or more zones from another via packers or complete sealing of the wellbore from passage of fluids there through via plugs.

The principle sealing elements on packers and plugs are generally formed of elastomeric materials as such elastomeric materials are well suited to down-hole applications. However, the same characteristics that make such elastomeric materials useful down-hole also make them susceptible to damage when running them down-hole.

Contained herein are embodiments directed to resolving, or at least reducing, one or all of the problems mentioned above.

### SUMMARY

The present disclosure generally includes one or more down-hole tools. The down-hole tools generally include a sealing assembly adapted for use down-hole, wherein the sealing assembly includes: a substrate including an elastomeric material; and a heat shrink film adhered to at least a portion of the substrate, wherein the heat shrink film includes a thickness when adhered to the at least a portion of the substrate in a range of about 7.5 mil to about 30 mil and exhibits an Elmendorf tear strength (as measured by ASTM D-1922) in a range of about 1000 g to about 5000 g.

One or more embodiments include the down-hole tool of the preceding paragraph, wherein the sealing assembly is either a packer or a plug.

One or more embodiments include the down-hole tool of any preceding paragraph, wherein the heat shrink film exhibits a specific gravity (as measured by ASTM D-792) when adhered to the at least a portion of the substrate in a range of about 2.12 to about 2.17.

One or more embodiments include the down-hole tool of any preceding paragraph, wherein the heat shrink film exhibits a tensile strength (as measured by ASTM D-882) when adhered to the at least a portion of the substrate in a range of about 3000 psi to about 4000 psi.

One or more embodiments include the down-hole tool of any preceding paragraph, wherein the heat shrink film exhibits a bursting strength (as measured by ASTM D-774) when adhered to the at least a portion of the substrate in a range of about 50 psi to about 250 psi.

One or more embodiments include the down-hole tool of any preceding paragraph, wherein the heat shrink film exhibits a coefficient of friction (as measured by ASTM D-1894) when adhered to the at least a portion of the substrate in a range of about 0.1 to about 0.3.

One or more embodiments include the down-hole tool of any preceding paragraph, wherein the heat shrink film exhibits a shrinkability (as measured by ASTM D-2732) when adhered to the at least a portion of the substrate of at least 20% in either a longitudinal direction, a transverse direction, or combinations thereof.

One or more embodiments include the down-hole tool of any preceding paragraph, wherein the heat shrink film exhibits an elastic modulus (as measured by ASTM D-882) when adhered to the at least a portion of the substrate in a range of about 60,000 psi to about 75,000 psi.

One or more embodiments include the down-hole tool of any preceding paragraph, wherein the heat shrink film performs within a service temperature range of about −50° F. to about 400° F.

One or more embodiments include the down-hole tool of any preceding paragraph, wherein the heat shrink film includes a thermoplastic material.

One or more embodiments include the down-hole tool of any preceding paragraph, wherein the heat shrink film includes a fluoropolymer.

One or more embodiments include the down-hole tool of any preceding paragraph, wherein the heat shrink film includes a fluorinated ethylene/propylene copolymer.

One or more embodiments include methods of manufacturing the down-hole tools of any preceding paragraph. In one or more embodiments, the methods generally include: adhering a heat shrink film to one or more elastomeric surfaces of a substrate which forms at least a portion of a component of the down-hole tool, wherein the heat shrink film is adhered to at least a portion of the substrate, wherein the heat shrink film includes a thickness when adhered to the at least a portion of the substrate in a range of about 7.5 mil to about 30 mil and exhibits an Elmendorf tear strength (as measured by ASTM D-1922) when adhered to the at least a portion of the substrate in a range of about 1000 g to about 5000 g.

One or more embodiments include the method of the preceding paragraph, wherein the adhering includes: contacting the one or more elastomeric surfaces with the heat shrink film; and applying heat to the heat shrink film to form a seal between the one or more elastomeric surfaces and the heat shrink film.

One or more embodiments include the method of any preceding paragraph, wherein the heat shrink film is in the form a sleeve.

One or more embodiments include methods of running the down-hole tool of any preceding paragraph down-hole. The method generally include: providing the down-hole tool, running the down-hole tool to a down-hole location; and setting the down-hole tool at the down-hole location.

While multiple embodiments are disclosed, still other embodiments will become apparent to those skilled in the art from the following detailed description. As will be apparent, certain embodiments, as disclosed herein, are capable of modifications in various obvious aspects, all without departing from the spirit and scope of the claims as presented herein. Accordingly, the drawings and detailed description are to be regarded as illustrative in nature and not restrictive.

### BRIEF DESCRIPTION OF THE DRAWINGS

The claimed subject matter may be understood by reference to the following description taken in conjunction with the accompanying drawings, in which like reference numerals identify like elements, and in which:

FIG. 1 illustrates a schematic of an embodiment of a specific, non-limiting embodiment of a well system.

FIG. 2 illustrates a schematic of an embodiment of an isolation tool.

FIG. 3 illustrates a schematic of an embodiment of a specific, non-limiting embodiment of a sealing assembly.

While the claimed subject matter is susceptible to various modifications and alternative forms, the drawings illustrate specific embodiments herein described in detail by way of example. It should be understood, however, that the description herein of specific embodiments is not intended to limit the claimed subject matter to the particular forms disclosed, but on the contrary, the intention is to cover all modifications, equivalents, and alternatives falling within the spirit and scope as defined by the appended claims.

### DETAILED DESCRIPTION

illustrative embodiments of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations disclosed herein is to be understood to set forth every number and range encompassed within the broader range of values. It is to be noted that the terms “range” and “ranging” as used herein generally refer to a value within a specified range and encompasses all values within that entire specified range.

As used herein, the terms “up” and “down”, “upper” and “lower”, “upwardly” and “downwardly”, “upstream” and “downstream”, “above” and “below” and other like terms indicating relative positions above or below a given point or element are used in this description to more clearly describe some embodiments of the invention. However, when applied to equipment and methods for use in wells that are deviated or horizontal, such terms may refer to a left to right, right to left or other relationship as appropriate.

Furthermore, various modifications may be made within the scope of the invention as herein intended, and embodiments of the invention may include combinations of features other than those expressly claimed. In particular, flow arrangements other than those expressly described herein are within the scope of the invention.

One or more embodiments described herein include down-hole tools. “Down-hole tools” are devices that often run into a well to perform some function in the well bore. The down-hole tools may be run into the well via known methods, such as jointed pipe, coiled tubing or wireline, for example. Jointed pipe is generally formed of a variety of operational components joined one after another and is adapted for lowering down a well bore. In operation, the each of the foregoing methods may include a number of function-specific tools that are lowered into a well bore, which may maintain an annular space between the tools and the interior surface of the well bore (whether cased or un-cased). However, it is recognized that the tools, or a portion of the tools may contact the interior surface of the well bore in operation.

Isolation tools, such as packers and plugs, are often utilized as down-hole tools for well production, intervention, stimulation, and/or as containment devices when wells, or portions of wells, are shut in and abandoned. Such isolation tools are capable of sealing at least a portion of a well bore to prevent fluid flow there through. For example, production packers generally seal at least a portion of an annulus (i.e., a space formed between an exterior wall of the production tubing and the interior wall of the well casing, liner or well bore wall). Based on their primary use, packers can be divided into two main categories: production packers and service packers. Production packers are generally those that remain in the well during well production while service packers are generally used temporarily during well service activities.

In multi-zone wells (i.e., wells having multiple layers or strata which should be isolated from one another), production packers are adapted to seal the annulus above or below a particular zone, such as a production zone. As used herein, the term “above” refers to a location between the particular zone and another point within the well or a collection point. It is contemplated and within the scope described herein that more than one packer may be utilized in a well bore.

Plugs are generally utilized for obstructing the flow continuity of an entire well bore, whether it is the entire cross-section of the well bore, the cross-section of a well casing or the cross-section of production tubing, for example.

The isolation tools generally are formed of a sealing element. The sealing element is generally formed of an elastomeric material that is in some manner secured and sealed to the interior well surface, which may be the interior casing wall or the raw well bore wall, for example. Such securing methods are generally known in the art and thus are not described in detail herein.

The elastomeric material includes elastomeric materials known in the art for use in such down-hole tools. Well conditions and requirements vary widely and thus, the specific elastomeric material will vary depending on specific well conditions. However, specific, non-limiting examples of elastomeric materials include nitriles, hydrogenated nitriles, fluoroelastomers, ethylene propylene diene rubber (EPDM), and combinations thereof, for example. In one or more embodiments, the well conditions include a service temperature in a range of about −50° F. to about 400° F., for example.

In operation, the isolation tools are run into the well bore and set in the target location via any method known in the art. For example, the isolation tools may be run into the well bore via wireline. Methods for setting the isolation tools are known in the art and thus are not described in greater detail herein. For example, the sealing element could be inflated, compressed or extended in any manner in keeping with the principles described herein, such as via one or more latching mechanisms.

Unfortunately, the running process can cause damage to the elastomeric material of the sealing element. For example, the running process can weaken the structural integrity of the sealing element due to fluid friction, which may contain particulates or other debris, applied to the relatively soft sealing element, friction from direct contact with the wellbore inner wall, or fluid dynamics forces causing deformation of the elastomer during the running process. However, the isolation tools described herein further include a heat shrink film adhered to at least a portion of the elastomeric material of the sealing element (referred to interchangeably herein as the “substrate”) to form a sealing assembly. As used herein, the term “heat shrink film” refers to a film capable of “shrinking” to form a seal with the substrate upon the application of heat.

The heat shrink film is adapted to provide protection to the substrate during the running process without affecting the functionality of the sealing element. Thus, the heat shrink film is such that it has a mechanical strength sufficient to maintain its integrity during the running process but is such that the mechanical strength may not be retained thereafter (e.g., the heat shrink film may degrade subsequent to the running process). The heat shrink film thickness is such that degradation during running is minimized. However, in one or more embodiments, the heat shrink film may have a thickness when adhered to the at least a portion of the substrate in a range of about 7.5 mil to about 30 mil, or about 10 mil to about 25 mil, or about 15 mil to about 20 mil, for example.

The heat shrink film when adhered to the at least a portion of the substrate may exhibit an Elmendorf tear strength (as measured by ASTM D-1922) in a range of about 1000 g to about 5000 g, for example. The heat shrink film when adhered to the at least a portion of the substrate may exhibit a specific gravity (as measured by ASTM D-792) in a range of about 2.12 to about 2.17, for example. The heat shrink film when adhered to the at least a portion of the substrate may exhibit a tensile strength (as measured by ASTM D-882) in a range of about 3000 psi to about 4000 psi, for example. The heat shrink film when adhered to the at least a portion of the substrate may exhibit a bursting strength (as measured by ASTM D-774) in a range of about 50 psi to about 250 psi, for example. The heat shrink film when adhered to the at least a portion of the substrate may exhibit a coefficient of friction (as measured by ASTM 1894) in a range of about 0.1 to about 0.3, for example. The heat shrink film when adhered to the at least a portion of the substrate may exhibit an elastic modulus (as measured by ASTM D-882) in a range of about 60,000 psi to about 75,000 psi, for example.

The heat shrink film when adhered to the at least a portion of the substrate may exhibit a shrinkability (as measured by ASTM D-2732) of at least 20% in either a longitudinal direction, a transverse direction or combinations thereof, for example.

The heat shrink film may be formed of a material exhibiting one or more of the properties described herein without interfering with any pressure sealing functionality of the substrate. For example, the heat shrink film may be formed of one or more polyolefins, polyvinylchloride, ethyl vinyl acetate and combinations thereof in one or more embodiments, the heat shrink film is formed of a thermoplastic material. In one or more embodiments, the heat shrink film is formed of a fluoropolymer. As used herein, the term “fluoropolymer” refers to a fluorocarbon based polymer. For example, the heat shrink film may be formed of a fluorinated ethylene/propylene copolymer.

The heat shrink film is adhered to the at least a portion of the substrate via methods known in the art. For example, the heat shrink film may be applied to (e.g., contact) at least a portion of the substrate and heat applied thereto to form a seal between the substrate and the heat shrink film. The heat shrink film may be applied to at least that portion of the substrate exposed to friction during the running process. In one or more embodiments, the heat shrink film is applied to substantially all of the exposed substrate (i.e., substrate that is not in contact with another material prior to the running process, such as setting elements, for example). In yet other embodiments, the heat shrink film is applied to the entirety of an exterior surface/elastomeric surface of the downhole tool. In such embodiments, the heat shrink film may be in the form of a sleeve, which can be slipped over the substrate prior to heating. As used herein, the term “sleeve” refers to a tubular part designed to fit over another part. The inner and outer surfaces of the sleeve may be circular or non-circular in cross-section profile. The inner and outer surfaces may generally have the same or different geometries. More generally, a sleeve may be considered to be a generalized hollow cylinder with one or more radii or varying cross-sectional profiles along the axial length of the cylinder. Alternatively, the heat shrink film may be in the form of a sheet, which may be wrapped around the substrate prior to heating. Heat may be applied via methods known in the art, such as via a heat gun or oven, for example.

In operation, it is contemplated that the heat shrink film may be adhered to the substrate to form the sealing assembly prior to running the isolation tool down-hole. As such, the sealing assemblies described herein exhibit resistance to erosion, degradation and/or injury during running process. The sealing assemblies further function to minimize swabbing within the well bore (which can result in bursting, or outward deformation, of the isolation tool, or components thereof). As used herein, the term “swabbing” refers to the elastomer's tendency to deform or swell in a way which reduces the annular area between the outer diameter of the isolation tool and the inner wall of the wellbore. If this area were to reduce (the tool begins to swab), fluid pressure above the tool increases, tool speed decreases, and there is greater chance of elastomer damage as it becomes more exposed to contact with the wellbore wall. Further, such running processes are capable of faster operation (e.g., at least 20%, or at least 25%, or at least 30% faster) that processes utilizing isolation tools absent the heat shrink film, for example. For example, the isolation tools may be run down-hole at running speeds of at least 300 ft/min. Such speeds are obtainable without failure of the heat shrink film. For example, such speeds are obtainable without the heat shrink film dislodging from the underlying substrate during running operations. Further, such speeds are obtainable without penetration of foreign objects through the heat shrink film to come into contact with the substrate during running operations.

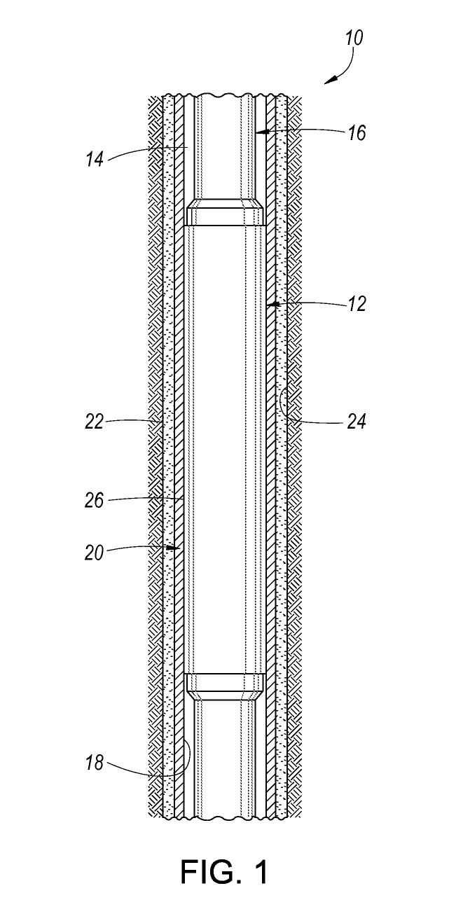

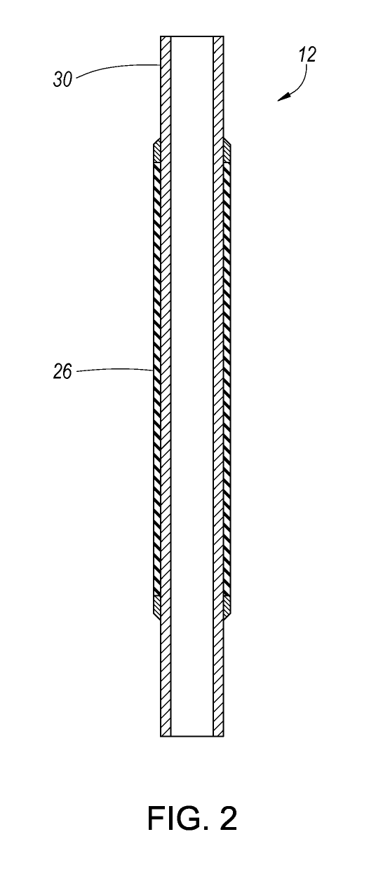

FIG. 1 illustrates a schematic of an embodiment of a specific, non-limiting embodiment of a well system. In the well system 10, an isolation tool 12 is used to provide a fluid and pressure barrier in an annulus 14 formed between production tubing 16 and a well bore interior surface 18. Although the interior surface 18 is depicted in FIG. 1 as being formed on an interior of a casing, liner or other type of tubular string 20 which is encased in cement 22, the interior surface 18 could instead be formed on interior wall of a formation 24 (for example, in an uncased portion of the well), or could be any other surface in the well bore. The isolation tool 12 includes a sealing assembly 26 which is outwardly extended in order to sealingly engage the interior surface 18. FIG. 2 further illustrates a schematic cross-sectional view of the isolation tool 12 disposed on the production tubing 30 including the sealing element 26 representatively illustrated apart from the remainder of the well system 10.

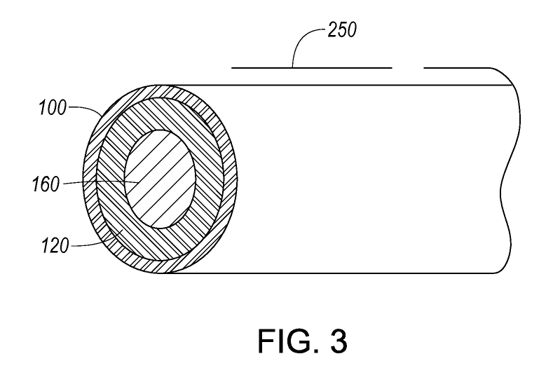

FIG. 3 illustrates an embodiment of an sealing assembly 250 including a sleeve of heat shrink film 100 covering a substrate 120 having a hollow portion 160 running there through, which is adapted for assembly and running down-hole.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

Each and every patent or other publication or published document referred to in any portion of this specification is incorporated in toto into this disclosure by reference, as if fully set forth herein.

This invention is susceptible to considerable variation in its practice. Therefore the foregoing description is not intended to limit, and should not be construed as limiting, the invention to the particular exemplifications presented hereinabove.

What is claimed is:

1. A down-hole tool comprising:
a sealing assembly adapted for use down-hole, wherein the sealing assembly comprises:
a substrate comprising an elastomeric material; and
a heat shrink film adhered to at least a portion of the substrate, wherein the heat shrink film comprises a thickness when adhered to the at least a portion of the substrate in a range of about 7.5 mil to about 30 mil and exhibits an Elmendorf tear strength (as measured by ASTM D-1922) in a range of about 1000 g to about 5000 g.

2. The down-hole tool of claim 1, wherein the sealing assembly is either a packer or a plug.

3. The down-hole tool of claim 1, wherein the heat shrink film exhibits a specific gravity (as measured by ASTM D-792) when adhered to the at least a portion of the substrate in a range of about 2.12 to about 2.17.

4. The down-hole tool of claim 1, wherein the heat shrink film exhibits a tensile strength (as measured by ASTM D-882) when adhered to the at least a portion of the substrate in a range of about 3000 psi to about 4000 psi.

5. The down-hole tool of claim 1, wherein the heat shrink film exhibits a bursting strength (as measured by ASTM D-774) when adhered to the at least a portion of the substrate in a range of about 50 psi to about 250 psi.

6. The down-hole tool of claim 1, wherein the heat shrink film exhibits a coefficient of friction (as measured by ASTM D-1894) when adhered to the at least a portion of the substrate in a range of about 0.1 to about 0.3.

7. The down-hole tool of claim 1, wherein the heat shrink film exhibits a shrinkability (as measured by ASTM D-2732) when adhered to the at least a portion of the substrate of at least 20% in either a longitudinal direction, a transverse direction, or combinations thereof.

8. The down-hole tool of claim 1, wherein the heat shrink film exhibits an elastic modulus (as measured by ASTM D-882) when adhered to the at least a portion of the substrate in a range of about 60,000 psi to about 75,000 psi.

9. The down-hole tool of claim 1, wherein the heat shrink film performs within a service temperature range of about −50° F. to about 400° F.

10. The down-hole tool of claim 1, wherein the heat shrink film comprises a thermoplastic material.

11. The down-hole tool of claim 1, wherein the heat shrink film comprises a fluoropolymer.

12. The down-hole tool of claim 1, wherein the heat shrink film comprises a fluorinated ethylene/propylene copolymer.

13. A method of manufacturing a down-hole tool comprising:
adhering a heat shrink film to one or more elastomeric surfaces of a substrate which forms at least a portion of a component of the down-hole tool, wherein the heat shrink film is adhered to at least a portion of the substrate, wherein the heat shrink film comprises a thickness when adhered to the at least a portion of the substrate in a range of about 7.5 mil to about 30 mil and exhibits an Elmendorf tear strength (as measured by ASTM D-1922) when adhered to the at least a portion of the substrate in a range of about 1000 g to about 5000 g.

14. The method of claim 13, wherein the adhering comprises:
contacting the one or more elastomeric surfaces with the heat shrink film; and
applying heat to the heat shrink film to form a seal between the one or more elastomeric surfaces and the heat shrink film.

15. The method of claim 13, wherein the heat shrink film is in the form a sleeve.

16. A method of running a tool down-hole comprising:
providing a down-hole tool comprising:
a sealing assembly adapted for use down-hole, wherein the sealing assembly comprises:
a substrate comprising an elastomeric material; and
a heat shrink film adhered to at least a portion of the substrate, wherein the heat shrink film comprises a thickness when adhered to the at least a portion of the substrate in a range of from about 7.5 mil to about 30 mil and exhibits an Elmendorf tear strength (as measured by ASTM D-1922) in a range of about 1000 g to about 5000 g; and
running the down-hole tool to a down-hole location; and
setting the down-hole tool at the down-hole location.
